(19) United States
(12) Patent Application Publication
(10) Pub. No.: US 2009/0134651 A1
(43) Pub. Date: May 28, 2009

(54) Commercial Vehicle Cab Accessory Mounting System

(75) Inventors: Edvard Bang, Västra Frölunda (SE); Hanna Ljungqvist, Göteborg (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 11/721,687

(22) PCT Filed: Mar. 10, 2005
(86) PCT No.: PCT/SE2005/000356

§ 371 Date: Jun. 14, 2007

(51) Int. Cl. B60R 7/00; B60R 9/00

(52) U.S. Cl. 296/37.7; 224/321

(57) ABSTRACT

A driver's cab of a commercial vehicle includes at least one rail mounted to the exterior of the cab. The rail has an attachment structure extending along the rail enabling releasable attachment of designated accessories at optional positions along the attachment structure. A commercial vehicle cab accessory mounting system and use of such a system are also disclosed.

### FIELD OF THE INVENTION

The invention relates to a driver's cab of a commercial vehicle, comprising at least one rail being mounted to the exterior of said cab. The invention also relates to a commercial vehicle cab accessory mounting system and to the use of such a system.

### BACKGROUND OF THE INVENTION

The present invention refers to the field of commercial vehicles, such as trucks, lorries or busses. Commercial vehicles are generally adapted so as to transport goods on a platform, trailer or the like being arranged separate from a driver's cab. Thus the exterior of a driver's cab of a commercial vehicle is not designed to carry any substantial goods or load.

In contrast, it is common to mount various accessories such as lamps, horns, wind deflectors, mirrors, signs etc. to the exterior of a cab of a commercial vehicle. The accessories provide a possibility for the owner of the vehicle to tailor the exterior of the cab to his/her own needs or preferences.

The means previously proposed for fastening accessories to the cab are numerous and exhibit great variety. This is partly due to the fact that the accessories to be fastened are of varying appearance and function. It is also due to the fact that it is often desired to fasten accessories to different areas of the exterior of the cab, such as e.g. the roof, the lower or centre area of the front, the side walls or the rear.

Sometimes, accessories are fastened directly to the exterior wall of the cab, by means of e.g. bolts or welding. An alternative approach, in particular for mounting accessories to the roof of a cab, is to fasten an intermediary support bar to the exterior roof and to bolt or wedge the accessory onto the bar.

### SUMMARY OF THE INVENTION

An object of the invention is to provide a solution for fastening of accessories to the exterior of a driver's cab of a commercial vehicle, allowing for flexible attachment of accessories to the cab. Preferably, the system should allow for fastening of a diverse range of accessories, such as wind deflectors, mirrors, lamps, horns etc. Advantageously, the system should be suitable for any exterior area of a cab.

The above-mentioned object is achieved by a driver's cab of a commercial vehicle, comprising at least one rail being mounted to the exterior of said cab, wherein said rail forms integral attachment means extending along the rail enabling releasable attachment of designated accessories at an optional position along the attachment means.

It is to be understood, that with the term “commercial vehicle” is meant vehicles such as e.g. lorries, trucks, busses and delivery vans.

With the term “designated accessories” is meant accessories being suitable for fastening to the rails, either directly or via an intermediate fastening means. With accessories is meant functional accessories such as lamps, mirrors, horns, air deflectors etc. , which are functional, in contrast to goods or load for transport.

The proposed cab presents a rail forming integral attachment means extending along the rail. The attachment means is thus a part of the rail itself. Accessories may be mounted at optional positions along the attachment means, which provides the desired flexibility as regards the positioning of the accessories. The attachment means enables releasable attachment of the accessories, meaning that accessories can be placed and replaced along the attachment means without necessitating alterations or causing damage to the attachment means or the accessories.

The proposed rail has the advantage of being arrangable at any area of the exterior of the cab, such as the roof, the front, the sides, the rear, the bottom etc.

Advantageously, the attachment means enable releasable attachment of designated accessories by mechanical interlocking. Such a mechanical interlocking can be achieved e.g. by the attachment means forming a male/female connection with the designated accessory.

In one embodiment, the attachment means may comprise a number of attachment formations being arranged sequentially along the rail. Each attachment formation provides a position for attachment of an accessory to the rail. The attachment formations could come in many forms and shapes, such as e.g. a number of indentations or the like distributed along the rail. The attachment formation may advantageously be distributed along the full length of the rail, so as to provide a sufficient number of attachment positions.

In a more preferred embodiment, however, the attachment means may be formed as a profile extending along the rail. Such a profile provides possible attachment positions anywhere along its extension, thus providing maximum flexibility in the choice of location for an accessory. Furthermore, an accessory or an intermediate fastening device may be slid along the profile so as to reach a desired position.

In a preferred embodiment, the attachment means comprises a groove extending along the rail. Advantageously, the cross-section of the groove could define an inner portion for receiving a counteracting element for fastening of an accessory, and an outer portion being narrower than said inner portion, so as to form a stop for extraction of a counteracting element received in the inner portion in a direction transverse to the length of the rail.

This embodiment enables convenient releasable connection of accessories to the rail. As an example, accessories may be attached to the attachment means using a bolt and a counteracting element, such as a nut plate. The counteracting element may be inserted in the inner portion of the groove from a short end of the groove or alternatively from an insertion opening being provided along the groove, and slid in the inner portion so as to reach a desired position for fastening an accessory. Once the counteracting element is in place, a bolt being associated with the accessory may be brought through the narrow outer portion of the groove to engage to the counter element so as to fasten the accessory.

In addition to the inner and outer portion of the groove described above, the groove may further define an outermost portion being wider than the outer portion, so as to form a guide portion for receiving guide means of a designated accessory.

Such a guide portion could act as sole attachment means for a compressible element being introduced into the guide portion and retained by friction. Such an attachment would however only be suitable for attachment of relatively small or light articles, being exposed only to moderate forces when in use.

When an article is attached using the inner and outer portion of the groove as described above, the guide portion may act to guide the accessory towards an attachment position, and to stabilize the accessory once attached.

A groove having the above-mentioned outer and inner portions, and a wider outermost portion may thus provide for two different attachment possibilities: by bolts or the like using a counter-element in the inner portion of the groove or by friction, using the outermost portion of the groove for receiving a compressible element.

The friction function of a guide groove may naturally also be obtained if the guide groove is arranged separately, without any outer and inner portions for counter-acting elements.

Further, accessories may be attached by clamping about the rail, in which case the groove may be used to provide additional support for a clamping bracket or the like.

The inner and outer portions may advantageously be provided by a groove having a T-shaped cross-section. The wider guide portion may be provided by a groove having a C-shaped cross-section.

In one preferred embodiment, the rail is mounted flush with the exterior of the cab. This arrangement is advantageous since it enables use of a rail essentially without contribution to the wind resistance of the cab.

Preferably, the driver's cab may comprise a plurality of rails, each of said rails having similar attachment means extending along the rail.

Advantageously, the driver's cab may have a first pair of rails, extending essentially in parallel to each other, and being mounted to the cab outer wall, and at least one transverse rail, being attached to the first pair of rails via the attachment means and extending transversely between said first pair of rails.

Thus, the rails may be used not only to attach accessories, but also to attach another rail, if necessary by means of an intermediary fastening device. Transverse rails may be attached at any position between two parallel rails, and may be re-positioned along the parallel rails as desired. This arrangement is particularly useful for attaching accessories on the roof of the cab, where it is sometimes desirable to have accessories arranged one after the other on transverse rows.

In another aspect of the invention, there is provided a commercial vehicle cab accessory mounting system comprising at least one rail, said rail having attachment means extending along the rail enabling releasable attachment of designated accessories at an optional position along the attachment means, for mounting said designated accessories to a driver's cab of a commercial vehicle.

In yet another aspect of the invention, there is provided the use of a system as above for mounting at least one accessory to a driver's cab of a commercial vehicle.

Embodiments and alternatives with corresponding advantages as presented above in relation to the driver's cab according to the invention are similarly applicable to the other aspects of the invention.

### BRIEF DESCRIPTION OF THE ACCOMPANYING DRAWINGS

Other features and advantages of the present invention will appear more clearly from the following description of exemplary embodiments, wherein

FIG. 1 illustrates an embodiment of a driver's cab of a commercial vehicle comprising a rail system.

FIG. 2 illustrates an embodiment of a rail.

FIG. 3 illustrates the cross-section of the rail of FIG. 2.

FIG. 4 illustrates an example of fastening of accessories to the rail of FIG. 2.

FIG. 5 illustrates another example of fastening of accessories to the rail of FIG. 2.

FIG. 6 illustrates an assembly of several rails of the type shown in FIG. 2.

FIG. 7 illustrates an embodiment of a cab where the rails are mounted flush with the exterior wall of the cab.

FIG. 8 illustrates an embodiment of a rail where the attachment means comprises a row of individual attachment formations.

### DETAILED DESCRIPTION OF PREFERRED EMBODIMENTS OF THE INVENTION

Features and advantages of the invention will now be described in relation with an exemplary embodiment.

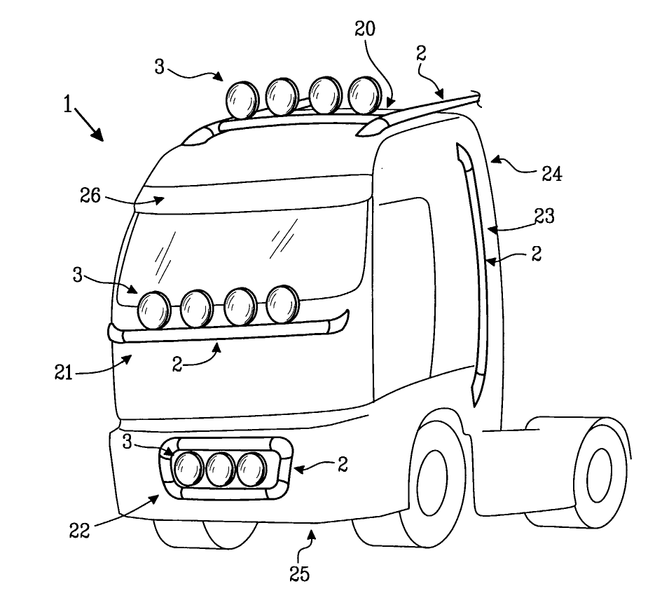

FIG. 1 illustrates schematically an embodiment of a driver's cab 1 of a commercial vehicle comprising a number of rails 2 being mounted to the exterior of the cab 1. The rails 2 are provided with attachment means extending along the rail enabling releasable attachment of accessories 3, illustrated as lamps in the example of FIG. 1.

In FIG. 1, similar rails 2 are attached to different areas of the exterior of the cab 1, namely to the lower front area, the centre front area, the roof and the side wall. Since the rails 2 enable releasable attachment of the accessories 3, as will be described in the following, the accessories 3 may easily be moved from one area of the cab to another, or be removed or replaced.

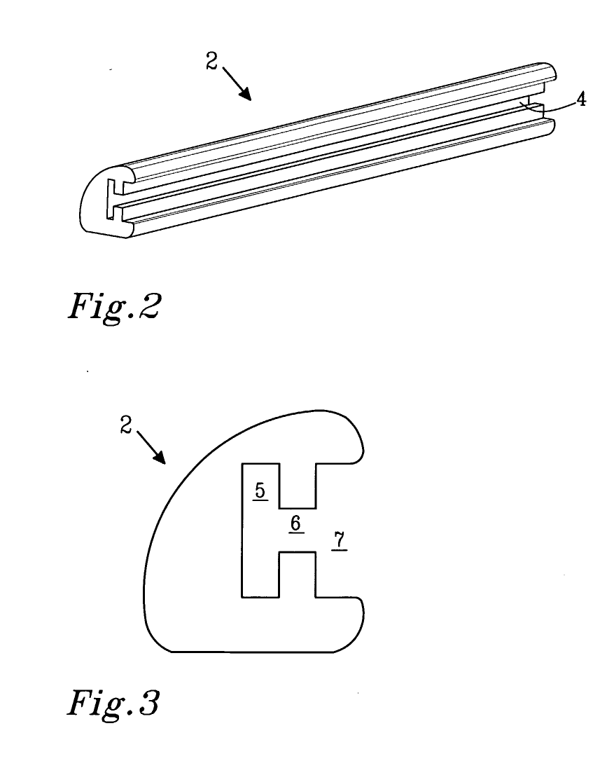

FIG. 2 illustrates an embodiment of a rail 2 being suitable for the present purpose. The rail 2 is provided with attachment means 4 extending along the rail 2.

In the illustrated embodiment, the attachment means 4 extends along substantially the entire length of the rail 2. However, it is possible to provide rails 2 where the attachment means 4 extends along only a part of the rail length. Nevertheless, it is naturally preferred that the attachment means extends along a substantial part of the rail so as to enable attachment along the majority of its length, and preferably along substantially the full length thereof. Thus the attachment means may advantageously extend along more than 50% of the length of the rail, preferably more than 75%, and most preferred more than 90%.

The attachment means 4 of FIG. 2 provides for releasable attachment of accessories by mechanical interlocking, where the attachment means form a female connection to fit with a male connection of a designated accessory.

As seen in FIG. 2, the attachment means 4 is formed from a groove extending along the rail. The groove thus provides a continuous attachment means, allowing for stepless positioning of accessories.

FIG. 3 illustrates the cross-section of the embodiment of a rail 2 illustrated in FIG. 2. The groove 4 defines an inner portion 5 and an outer portion 6, being narrower than the inner portion in a direction perpendicular to the length of the rail. The inner portion is adapted to receive a counteracting element for fastening of an accessory, and the outer portion 6 is narrower than the inner portion 5 so as to form a stop for extraction of such a counteracting element received in the inner portion in a direction transverse to the length of the rail.

Further, the groove 4 defines in this case an outermost portion 7 being wider than the outer portion 6. This purpose of the outermost portion 7 of the groove is to form a guide portion for receiving guide means of a designated accessory or a fastening device for such an accessory.

As seen in FIG. 3, the inner portion 5 and the outer portion 6 of the groove forms the shape of a T where the base of the T is directed towards the opening of the groove. The outermost portion 7 forms the shape of a C with its opening defining the outermost opening of the groove. Thus the groove 4 has a relatively wide inner portion 5, a relatively narrow outer portion 6, and widens again to an outermost portion 7, in this case being just as wide as the inner portion 5.

In the illustrated embodiment, the end of the rail 2 opposing the groove 4 has a rounded shape, which is advantageous from an esthetical and practical point of view. However, numerous other shapes may naturally be envisaged.

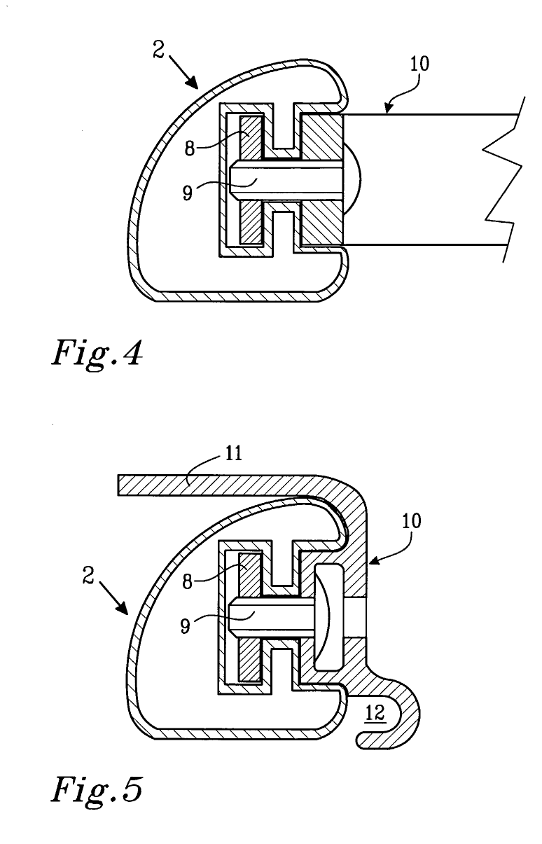

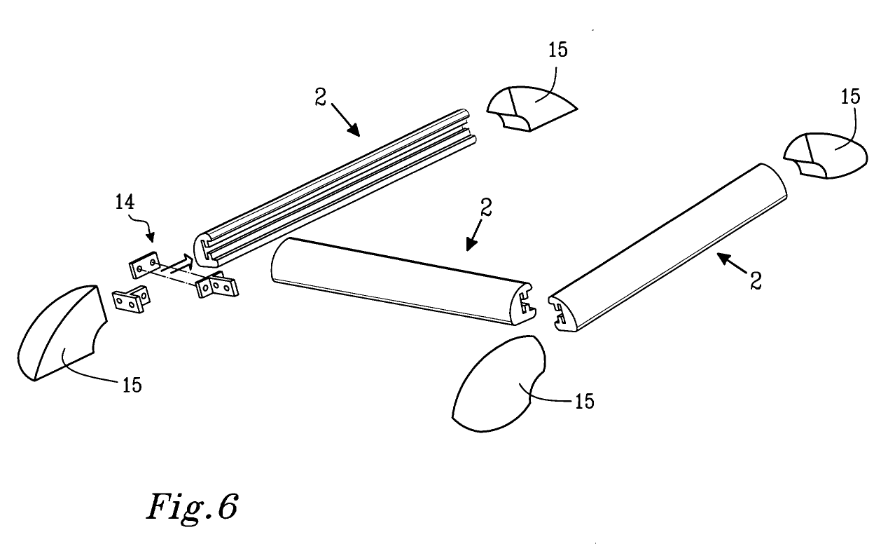

FIGS. 4 and 5 are illustrative examples showing how fastening of accessories to a rail as described in FIGS. 2 and 3 may be accomplished.

FIG. 4 shows schematically how fastening is performed using the T-shaped inner portion 5 and 6 of the groove 4.

A counter-acting element 8 is received in the inner portion 5 of the groove 4, and is engageable by a fastening element 9, such as a bolt, to fasten an accessory, either directly or via a fastening console 10.

The counteracting element 8 could be inserted before mounting of the rail 2, via one of the open short ends thereof. Alternatively, openings or lids could be provided at one or more specific locations along the groove 4, where the narrower outer portion 6 is widened so as to enable introduction of a counter-acting element 8 into the groove.

Counteracting elements could be introduced in a number corresponding to the needs for fastening a previewed number of accessories. Thus, the function, form and size of each counteracting element may be selected to match the specific accessory.

However, it could be advantageous to introduce an optional number of counteracting elements 8 into the groove 4 e.g. before mounting the rail 2, so as to provide a number of fastening possibilities, where the user might choose to make use of all or only some thereof. Also, one counteracting element could include a number of fastening positions, i.e. the counteracting element could form a strip in which a number of holes are provided for receiving fastening elements 9.

In another embodiment, the counteracting element 8 may have an elongate shape, so as have a width being less than the width of the narrower portion 6 of the groove 4, and a length exceeding the width of the narrower portion 6 of the groove 4. Such a counter-acting element may be directed along the groove 4 for introduction to the inner portion 5 into via the narrower portion 6 of the groove 4. Once in place in the inner portion 5, the elongate counteracting element may be pivoted, preferably 90 degrees, such that its longest extension forms a stop for withdrawal of the counteracting element via the groove 6.

In yet another embodiment, the groove may be provided with friction means for enhancing the friction between a counteracting element received in the groove and the walls of the groove so as to retain the counteracting element in position in the groove. Such friction means could for example comprise protrusions or indentations formed along inner walls of the groove.

The counter-acting elements 8 may advantageously have a form corresponding to the inner portion 5 of the groove 4 so as to be slidable therein. Thus, any counter-acting element 8 received in the inner portion 5 of the groove may be slid to an optional position for fastening an accessory.

It is understood that the fastening of an accessory in the above-mentioned manner may be made at an optional position along the attachment means 4. The fastening does not cause any alteration or damage, such as e.g. bore holes, of the rail 2. Instead, the accessories are releasably attached such that they may be attached, removed and reattached at optional positions of the rail. Accordingly, the user has full liberty of choice for designing and re-designing the exterior of the driver's cab.

In FIG. 4, it is seen how a portion of an accessory or fastening device 10 extends into the outermost guide portion 7 of the groove 4. Thus the outermost portion 7 serves to guide the fastening device 10 and to enhance its stability. Further, the head of the fastening means 9, in this case a bolt, may be confined to the space within the outermost portion 7 of the groove 4. Thus, bolt heads or the like protruding from the rail 2 may avoided.

FIG. 5 illustrates an alternative embodiment for fastening of an accessory to a rail 2 as depicted in FIG. 2. In this case, a bracket 11 is attached to the rail 2 in a similar manner as the fastening portion 10 of FIG. 4. The bracket 11 forms a space 12 between the bracket and the outer surface of the rail 2, in this case at a position adjacent to the groove 4. Such a space 12 may be used e.g. for accommodating cables or the like that might be associated to the accessory to be mounted. In addition, the bracket 11 forms a platform 13 with a flat surface extending over the rail 2, enabling fastening of accessories 2 to a position on the platform 13. Naturally numerous forms of brackets 11 may be envisaged for fastening different types of accessories.

Further, brackets may be designed to be clamped about the rail 2, preferably using at laest the outermost portion 7 of the groove 4 to provide additional support for the bracket. In this case, no counteracting elements or fastening elements are needed. However, generally, attachment using counteracting elements and fastening elements may be made more stable and convenient that attachment by clamping. Nevertheless, a rail providing double attachment possibilities: fastening element/counteracting element or clamping, will provide the user with numerous options for fastening of different types of accessories to the rails.

FIG. 6 is an exploded view of an embodiment where a plurality of rails 2 are connected to form a rack for attachment of accessories. A first pair of rails 2 is arranged to extend essentially in parallel to each other, and a transverse rail 2′ is mounted to extend between the first pair of rails 2. For attachment of the transverse rail 2′ between the parallel rails 2, fastening means 14 comprising a T-shaped fastening element and a counteracting element may be used. The base of a T-shaped fastening element may be fastened in the groove 4 of the transverse rail 2′ at one end thereof, and the top of the T-shaped fastening element may be fastened in the groove 4 of one of the parallel rails 2 at an optional position along the length of the parallel rail 2.

Thus, the rails 2 may be used to form a rack where the number of transverse rails 2′ may be adjusted, as well as the distance between individual transverse rails 2′. The transverse rails 2′ are attachable and removable from the parallel rails 2 at the choice of a user.

In the illustrated embodiment of FIG. 6, only the first pair of rails 2 needs to be mounted to the driver's cab 2. To this end, cab mounting elements 15 are arranged at the ends of the parallel rails 2, in this case using T-shaped fastening elements 14. Thus, the rails 2 may be mounted separate from the exterior wall of the cab, where the cab mounting elements 15 extending from the exterior wall of the cab so as to hold the rails 2 in position at a distance from the cab outer wall. This type of arrangement is similar to the one seen in FIG. 1.

Use of a parallel pair of rails 2 as described above for forming a rack is particularly advantageous at the roof area of a driver's cab. There, it may be used in particular for mounting of wind deflectors which is a rather voluminous type of accessory that may often require several fastening positions. Naturally, also signs, lamps, horns etc may be attached to such a rack.

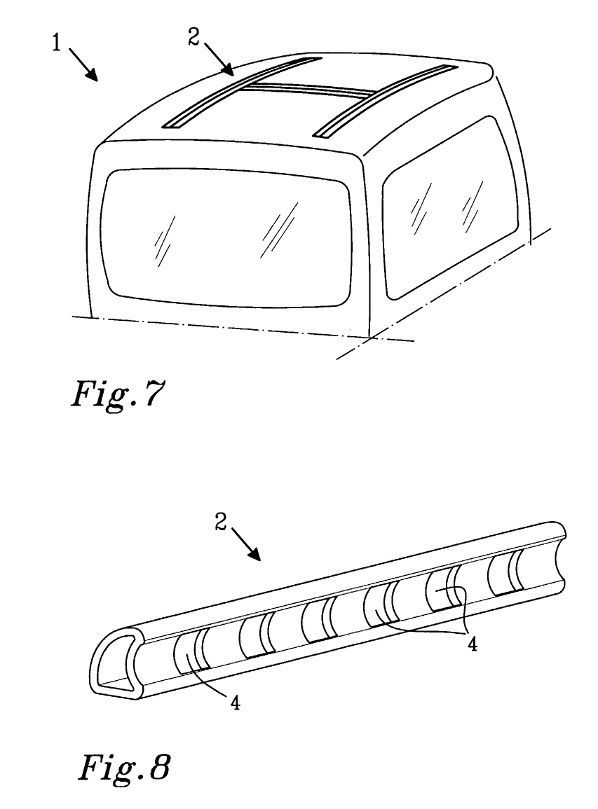

In an alternative embodiment, the rails 2 may be arranged flush with the cab outer wall. Such an arrangement is schematically depicted in FIG. 7. In this embodiment, the rails 2 are integrated with the outer wall of the roof of the cab 1. The fastening means 4 will preferably be directed outwards from the cab wall, and may be designed in numerous different ways, including the preferred embodiments as described above. The rails 2 being arranged flush with the cab outer wall means that essentially no contribution to the wind resistance of the cab is caused by the rails 2. Also, the rails per se will not alter the general outer appearance of the cab, which might be advantageous from an aesthetical point of view.

For maximum benefit of the invention, rails 2 may be provided at several areas of a driver's cab, such as the roof area 20, a centre front area 21, a lower front area 22, a side wall 23, the rear 24 and the bottom 25 as illustrated in FIG. 1. The rails 2 should preferably have essentially identical attachment means 4 extending along the rails 2, so as to enable the accessories or fastening devices to be attached to any area or replaced from any area to another.

FIG. 8 depicts an alternative embodiment of a rail 2 having attachment means 4 extending along the length of the rail, wherein the attachment means 4 is formed by a number of discrete attachment formations 16 being arranged sequentially along the rail. Each attachment formation 16 provides a position for attachment of an accessory to the rail. In this case, the attachment formations 16 form indentations in the rail 2, to which accessories may be attached. The indentations 16 may advantageously have a cross-section similar to those described above, being suitable for receiving a counteracting element. Alternatively, the indentations 16 may be shaped so as to receive a fastening element such as a bolt. This embodiment is however not as flexible for fastening of different types of devices using different attachment means as embodiments where a counteracting element may be selected for each different case. Further, the embodiments using discrete attachment formations do naturally not exhibit the advantage of stepless adjustment of the position of the accessories.

In the above, the invention has been described in relation to exemplary embodiments. It is understood that numerous alternative embodiments are possible. The cross-section of the rails 2 may be varied in many different manners so as to accomplish functional attachment means extending along the length of the rails. Fastening means or brackets for use with the rails may have various shapes and sizes, as long as they correspond to the attachment means of the rail.

1. Driver's cab of a commercial vehicle, comprising at least one rail being mounted to an exterior of the cab, wherein the rail defines an integral attachment structure extending along the rail enabling releasable attachment of at least one accessory at at least one optional position along the attachment structure, the attachment structure comprising a groove extending along the rail, wherein the groove, as seen in cross-section, defines an inner portion for receiving a counteracting element for fastening of an accessory, and an outer portion being narrower than the inner portion, so as to form a stop for extraction of the counteracting element when received in the inner portion in a direction transverse to a length of the rail, the groove further defining an outermost portion wider than the outer portion, so as to form a guide portion for receiving a guide of a accessory.

2. Driver's cab according to claim 1, wherein the attachment structure enables releasable attachment of at least one accessory by mechanical interlocking.

3. Driver's cab according to claim 2, wherein the attachment structure forms at least one of a male and a female connection to fit with at least one of a female and a male connection, respectively of the at least one accessory.

4. Driver's cab according to claim 1, wherein the groove has a cross-section of which at least a part forms a T.

5. Driver's cab according to claim 1, wherein the groove has a cross-section of which at least a part forms a C.

6. Driver's cab according to claim 1, wherein the rail is mounted flush with the exterior wall of the cab.

7. Driver's cab according to claim 1, wherein the rail is provided with cab mounting means for affixing the rail to the cab.

8. Driver's cab according to claim 1, the cab comprising a plurality of rails, each of the rails having at least one substantially identical attachment structure extending along the rail.

9. Driver's cab according to claim 1, having a first pair of rails, the first pair of rails extending substantially parallel to each other, and being mounted to the exterior of the cab, and at least one transverse rail extending transversely between the first pair of rails and being attached via the attachment structure of the first pair of rails.

10. Driver's cab according to claim 1, wherein at least one rail is mounted to at least two areas out of the following areas: a cab roof area, a cab lower front area, a cab centre front area, a cab top front area, a cab side area, a cab rear area, and a cab bottom area.

11. Driver's cab according to claim 1, wherein the rail comprises at least one of openings and lids provided at at least one location along the groove at which location the outer portion is widened so as to enable introduction of a counter-acting element into the groove.

12. Driver's cab according to claim 1, further comprising at least one counteracting element received in the inner portion of the groove.

13. Driver's cab according to claim 12, wherein the counteracting element has a form corresponding to the inner portion of the groove so as to be slidable therein.

14. Driver's cab according to claim 12, wherein the counteracting element is in a form of a strip in which at least one hole are provided for fastening of at least one accessory.

15. Driver's cab according to claim 12, wherein the counteracting element has an elongate shape, a width of the counteracting element being less than the outer portion of the groove, and a length of the counteracting element exceeding the width of the outer portion of the groove, such that the counteracting element is adapted to be directed along the groove for introduction to the inner portion via the outer portion of the groove, and to thereafter be pivoted, such that a longest extension of the counteracting element forms a stop for withdrawal of the counteracting element via the groove.

16. Driver's cab according to claim 12, comprising at least one accessory releasably attached to the rail by fastening to the counteracting element.

17. Driver's cab according to claim 16, wherein the at least one accessory has a guide received in the outermost portion of the groove.

18. Commercial vehicle cab accessory mounting system comprising at least one rail, the rail having an attachment structure extending along the rail enabling releasable attachment of at least one accessory at at least one optional position along the attachment structure, for mounting the at least one accessory to a driver's cab of a commercial vehicle, the attachment structure comprising a groove extending along the rail, wherein the groove, as seen in cross-section, defines an inner portion for receiving a counteracting element for fastening of an accessory, and an outer portion that is narrower than the inner portion, so as to form a stop for extraction of the counteracting element when received in the inner portion in a direction transverse to a length of the rail, and wherein the groove further defines an outermost portion that is wider than the outer portion, so as to form a guide portion for receiving a guide of the at least one accessory.

19. Commercial vehicle cab accessory mounting system according to claim 18, wherein the attachment structure enables releasable attachment of at least one accessory by mechanical interlocking.

20. Commercial vehicle cab accessory mounting system according to claim 19, wherein the attachment structure forms at least one of a male and a female connection to fit with a at least one of a female and a male connection, respectively of the at least one accessory.

21. Commercial vehicle cab accessory mounting system according to claim 18, wherein the groove has a cross-section of which at least a part forms a T.

22. Commercial vehicle cab accessory mounting system according to a claim 18, wherein the groove has a cross-section of which at least a part forms a C.

23. Commercial vehicle cab accessory mounting system according to claim 18, wherein the rail is provided with cab mounting elements.

24. Commercial vehicle cab accessory mounting system according to claim 18, wherein the rail comprises at least one of openings and lids provided at at least one location along the groove at which location the outer portion is widened so as to enable introduction of a counter-acting element into the groove.

25. Commercial vehicle cab accessory mounting system according to claim 18, further comprising at least one counteracting element received in the inner portion of the groove.

26. Commercial vehicle cab accessory mounting system according to claim 25, wherein the counteracting element has a form corresponding to the inner portion of the groove so as to be slidable therein.

27. Commercial vehicle cab accessory mounting system according to claim 25, wherein the counteracting element is in a form of a strip in which at least one hole is provided for fastening of at least one accessory.

28. Commercial vehicle cab accessory mounting system according to claim 25, wherein the counteracting element has an elongate shape, a width of the counteracting element being less than the outer portion of the groove, and a length of the counteracting element exceeding the width of the outer portion of the groove, such that the counteracting element is adapted to be directed along the groove for introduction to the inner portion via the outer portion of the groove, and thereafter be pivoted, such that a longest extension of the counteracting element forms a stop for withdrawal of the counteracting element via the groove.

29. Use of a system according to claim 18 for mounting of at least one accessory to a commercial vehicle cab.
